(19) United States
(12) Patent Application Publication
(10) Pub. No.: US 2018/0291260 A1
(43) Pub. Date: Oct. 11, 2018

(54) CROSSLINKER MODIFIED FILAMENT AND FABRIC FOR PLACEMENT OF PROPPANT ANTI-SETTLING AGENTS IN HYDRAULIC FRACTURES

(71) Applicant: Baker Hughes, a GE company, LLC, Houston, TX (US)

(72) Inventor: James B. Crews, Willis, TX (US)

(73) Assignee: Baker Hughes, a GE company, LLC, Houston, TX (US)

(21) Appl. No.: 15/948,657

(22) Filed: Apr. 9, 2018

Related U.S. Application Data
(60) Provisional application No. 62/484,072, filed on Apr. 11, 2017.

(51) Int. Cl. C09K 8/80; E21B 43/267

(52) U.S. Cl. CPC C09K 8/805; C09K 2208/08; E21B 43/267

(57) ABSTRACT

Compositions for suspending proppants in a hydraulic fracture of a subterranean formation involve a carrier fluid, a plurality of proppants, and a plurality of filaments, which optionally are comprised into a fabric that includes a plurality of connected filaments. The filaments contain crosslinkable sites, e.g. organo-borate, organo-zirconate, organo-titanate, and/or hydroxyl groups. A method of using the compositions includes hydraulically fracturing the subterranean formation to form fractures in the formation, during and/or after hydraulically fracturing the subterranean formation introducing proppants into the fractures, during and/or after hydraulically fracturing the subterranean formation introducing a plurality of filaments into the fractures, where the filaments contact and inhibit or prevent the proppant from settling by gravity within the fractures; and closing the fractures against the proppants. Inhibiting and/or preventing the proppants from settling is improved by the crosslinkable sites crosslinking a polymer present in a fluid contacting the filaments; e.g. a polysaccharide.

### CROSS-REFERENCE TO RELATED APPLICATION

This application claims the benefit of U.S. Provisional Patent Application Ser. No. 62/484,072 filed Apr. 11, 2017, incorporated herein by reference in its entirety.

### TECHNICAL FIELD

The present invention relates to methods and compositions for inhibiting or preventing proppants from settling within a hydraulic fracture formed in a subterranean formation; and more particularly relates to methods and compositions for inhibiting or preventing proppants from settling within a hydraulic fracture, which compositions can be readily pumped into the fracture after which crosslinking of a polymers occurs that enhances interacting with the proppants to prevent them from settling.

### TECHNICAL BACKGROUND

Hydraulic fracturing is the fracturing of subterranean rock by a pressurized liquid, which is typically water mixed with a proppant (often sand) and chemicals. The fracturing fluid is injected at high pressure into a wellbore to create, in shale for example, a network of fractures in the deep rock formations to allow hydrocarbons to migrate to the well. When the hydraulic pressure is removed from the well, the proppants, e.g. sand, aluminum oxide, etc., hold open the fractures once fracture closure occurs. In one non-limiting embodiment chemicals are added to increase the fluid flow and reduce friction to give “slick-water” which may be used as a lower-friction-pressure placement fluid. Alternatively in different non-restricting versions, the viscosity of the fracturing fluid is increased by the addition of polymers, such as crosslinked or uncrosslinked polysaccharides (e.g. guar gum) or by the addition of viscoelastic surfactants (VES). The thickened or gelled fluid helps keep the proppants within the fluid and thus within the fracture until the fracture closes upon the proppants. Because the proppants hold open the fracture, the local permeability of the formation is increased and hydrocarbons are produced more readily.

Recently the combination of directional drilling and hydraulic fracturing has made it economically possible to produce oil and gas from new and previously unexploited ultra-low permeability hydrocarbon bearing lithologies (such as shale) by placing the wellbore laterally so that more of the wellbore, and the series of hydraulic fracturing networks extending therefrom, is present in the production zone permitting production of more hydrocarbons as compared with a vertically oriented well that occupies a relatively small amount of the production zone; see FIGS. 1A and 1B. “Laterally” is defined herein as a deviated wellbore away from a more conventional vertical wellbore by directional drilling so that the wellbore can follow the oil-bearing strata that are oriented in a non-vertical plane or configuration. In one non-limiting embodiment, a lateral wellbore is any non-vertical wellbore. It will be understood that all wellbores begin with a vertically directed hole into the earth, which is then deviated from vertical by directional drilling such as by using whipstocks, downhole motors and the like. A wellbore that begins vertically and then is diverted into a generally horizontal direction may be said to have a “heel” at the curve or turn where the wellbore changes direction and a “toe” where the wellbore terminates at the end of the lateral or deviated wellbore portion. In one non-limiting embodiment, the “sweet-spot” of the hydrocarbon bearing reservoir is an informal term for a desirable target location or area within an unconventional reservoir or play that represents the best production or potential production. The combination of directional drilling and hydraulic fracturing has led to the so-called “fracking boom” of rapidly expanding oil and gas extraction in the US beginning in about 2003.

Most fractures have a vertical orientation as shown schematically in FIG. 1A which illustrates a wellbore 10 having with a vertical portion 12 and a lateral portion 14 drilled into a subterranean formation 16. Through hydraulic fracturing a fracture 28 having an upper fracture 18 and a lower fracture 20 have been created where there is fluid communication between upper and lower fractures 18 and 20, and proppant 22 is shown uniformly or homogeneously distributed in the fracturing fluid 24 of the upper and lower fractures 18 and 20. However, over long fracture closure times, and as the viscosity of the fracturing fluid decreases after fracturing treatments, the proppants 22 settle in the lower fracture 20 and the upper fracture 18 closes without proppant 22 to keep it open, thus operators lose the upper fracture 18 conductivity as schematically illustrated in FIG. 1B. The upper fracture 18 may be the location of the sweet spot horizon 26 of the shale play of the formation 16. The sweet-spot horizon 26 is defined herein as the horizon within the shale interval to be hydraulically fractured that will produce the most hydrocarbon compared to the shale horizons hydraulically fractured directly above and below.

Efforts have been made to make the proppant pack within a fracture more uniform. U.S. Pat. No. 9,010,424 to G. Agrawal, et al. and assigned to Baker Hughes, a GE company, involves disintegrative particles designed to be blended with and pumped with typical proppant materials, e.g. sand, ceramics, bauxite, etc., into the fractures of a subterranean formation to prop them open. With time and/or change in wellbore or environmental condition, these particles will either disintegrate partially or completely, in non-limiting examples, by contact with downhole fracturing fluid, formation water, or a stimulation fluid such as an acid or brine. Once disintegrated, the proppant pack within the fractures will lead to greater open space enabling higher conductivity and flow rates. The disintegrative particles may be made by compacting and/or sintering metal powder particles, for instance magnesium or other reactive metal or their alloys. Alternatively, particles coated with compacted and/or sintered nanometer-sized or micrometer sized coatings could also be designed where the coatings disintegrate faster or slower than the core in a changed downhole environment.

Insufficient carrier ability of fracturing fluids, particularly low-viscosity fluids, may result in proppant fallout during pumping and before closure takes place, giving rise to proppant banking in the lower part of the fractured segment of the reservoir. Proppant banking is detrimental to the result of simulation treatments if proppant banking provides preferential support of the fracture walls in the lower, water-bearing section of reservoirs with fluid stratification. Thus, it is desirable to find methods that avoid sand settling and banking.

Improvements are always needed in the driller's ability to increase and maintain the permeability of a proppant pack within a hydraulic fracture to improve the production of hydrocarbons from the subterranean formation.

### SUMMARY

There is provided in one non-restrictive version, a method of suspending proppants in a hydraulic fracture of a subterranean formation, where the method involves hydraulically fracturing the subterranean formation to form fractures in the formation, during and/or after hydraulically fracturing the subterranean formation, introducing proppants into the fractures, during and/or after hydraulically fracturing the subterranean formation, introducing a plurality of filaments into the fractures, where at least a portion of the filaments comprise a plurality of crosslinkable sites on the filaments, where the crosslinkable sites are selected from the group consisting of organo-borate, organo-zirconate, organo-titanate, hydroxyl groups, and combinations thereof, and closing the fractures against the proppants. Optionally, the crosslinkable sites on the filaments are chemically bonded to the filaments. Further the method may include crosslinking a polysaccharide in a fluid contacting the filaments with the crosslinkable sites.

There is additionally provided in another non-limiting embodiment, a fluid for suspending proppants in a hydraulic fracture of a subterranean formation, where the fluid includes a carrier fluid, a plurality of filaments, where at least a portion of the filaments comprise a plurality of crosslinkable sites on the filaments, where the crosslinkable sites are selected from the group consisting of organo-borate, organo-zirconate, organo-titanate, hydroxyl groups, and combinations thereof, and a plurality of proppants.

### BRIEF DESCRIPTION OF THE DRAWINGS

FIG. 1A is a schematic illustration of a wellbore with an upper and lower fracture depicting proppant uniformly distributed in a fracturing fluid in the upper and lower fracture, which is under hydraulic pressure to keep it open;

FIG. 1B is a schematic illustration of a wellbore with an upper and lower fracture depicting proppant having settled to the bottom of the lower fracture, the upper and lower fractures having closed, where the upper fracture is substantially completely closed due to the lack of proppant therein;

FIG. 2 is a schematic illustration of an upper fracture where proppant, filaments, and fabrics are uniformly or homogeneously distributed in a fracturing fluid under pressure therein;

FIG. 3 is a schematic illustration of the upper fracture of FIG. 2 where the proppant has been held in place by the filaments and/or fabric pieces, the fracture pressure has been released, and the fracture has closed onto the proppants which hold open the fracture; and

FIG. 4 is a schematic illustration of an upper fracture illustrating proppants, polymer molecules, and filaments comprising a plurality of crosslinkable sites thereon, where some of the polymers are crosslinked to the filaments, and the proppants are held in place by the crosslinked filaments and polymers and networks and/or associations of crosslinked filaments and polymers.

It will be appreciated that the drawings are not to scale and that certain features have been exaggerated for illustration or clarity.

### DETAILED DESCRIPTION

It has been discovered that filaments and small pieces of fabric comprising a plurality of filaments having a wide variety of physical shapes and forms may be transported with proppant into a hydraulic fracture. These filaments and small fabric pieces catch, hold, snag, wedge and otherwise engage proppants and temporarily hold them in place within the fracture. Thus, when pumping has been completed and the fracture closes, the fracture faces close against relatively uniformly distributed proppant placement to provide a relatively heterogeneous and uniformly improved permeability proppant pack in the fracture.

It will be appreciated that although proppants may be introduced during and/or after hydraulically fracturing the subterranean formation, in most cases proppants are introduced during the hydraulic fracturing operation.

In one non-limiting embodiment, all or at least a portion of the filaments comprise a plurality of crosslinkable sites on the filaments. The crosslinkable sites are selected from the group consisting of organo-borate, organo-zirconate, organo-titanate, hydroxyl groups, and combinations thereof. In one non-limiting embodiment the crosslinkable sites on the filaments are chemically bonded to the filaments. For instance, the filaments may be made of a polymer to which the crosslinkable sites are chemically bonded. In another non-limiting embodiment, the crosslinkable sites may be tiny particles that are physically bound or connected to or within the filaments.

In a non-restrictive alternative, when the filaments bearing the crosslinkable sites are being delivered to the fractures or are within the fracture, they are contacted with a fluid, typically a fracturing fluid (e.g. a brine-based fracturing fluid) that has a polymer therein (e.g. a crosslinkable polysaccharide). The crosslinkable sites then crosslink the polymer and the filaments are crosslinked to the polymers and the polymers are crosslinked to each other. Both of these crosslinked forms increase the viscosity of the fluid and help snag, catch, hold, wedge, engage and otherwise support the proppant within the fracture.

In another non-limiting embodiment, the fracturing fluid, e.g. a crosslinked polysaccharide, is used to fracture the formation and transport the proppant and the filaments into the fracture. Once the viscosity of the fracturing fluid is broken (reduced), the filaments will snag on each other and the fracture walls to support the proppant within the fracture and not let it settle or bank at the bottom of the fracture.

At least a portion of the filaments are all functional or functionalized, to have at least two functions or abilities: (1) they must be transportable with a fluid (defined herein as a liquid or gas) downhole to a subterranean formation and a hydraulic fracture within the subterranean formation. They may be part of, contained in, suspended in, dispersed in, and otherwise comprised by the fracturing fluid that fractures the formation. Alternatively they may be introduced subsequently into the hydraulic fracture in or by a subsequent fluid. This is true whether the filaments are separate or whether they are associated or interconnected as fabrics. Additionally (2) the filaments must have crosslinkable sites thereon. In one non-limiting embodiment the crosslinkable sites include organo-borate, organo-zirconate, and/or organo-titanate. Further, hydroxide functional groups on the surfaces of the filaments can be used as crosslinkable sites. Optionally, the filaments may also have (3) the function or ability to interact with the fracture face (fractured face of the formation) such as by dragging, skidding, snagging, catching, poking, wedging, anchoring, or otherwise engaging the sides of the fracture while also snagging, catching, holding, wedging, supporting, and otherwise engaging the proppant, which is also in the fluid, thereby holding the proppant in place relative to the fracture face to inhibit and/or prevent and/or be a localized support location for the proppant from settling into the lower portion of the fracture by gravity. In one non-limiting embodiment a localized support location is defined to mean as in a concentration distribution of at least every 2 inches, or at least every 4 inches, or even up to at least every 10 inches apart from each other. The filaments and/or fabric pieces will be localized in positions where proppant that begins to settle will only settle so far until they reach a filament or fabric position where the proppant will come to rest upon and not settle any further. Thus the filament or fabric is a localized support location that can vary in distances apart from each other. Filaments crosslinked with the polymers in the fluid (e.g. a brine-based fluid) and/or polymers crosslinked with each other will help facilitate fixing and securing the proppants in place prior to fracture closure. In other words, having the crosslinkable sites on the filaments permits them to “crosslink” with a polymer that forms a gel and provide better placement of the proppant after or when the gel breaks; thus the filaments or fabrics will anchor between the two opposing faces of the fracture and provide a mechanism to suspend the proppant after the gel of the fracturing fluid breaks. It will be appreciated that in most non-limiting embodiments when the fracturing fluid gel breaks, the bonds between the filaments and the polymers, e.g. polysaccharide, will also break. However, at that point the proppants will be in place, or substantially be in place. Some proppants may shift their positions slightly when the fracture attempts to close.

The filaments and fabrics are designed and configured to have a geometry and a composition to interact with fracture walls once treatment is completed, that is, when the treatment pumps are stopped and treatment fluid flow into hydraulic fractures ceases. The functional design of the filaments and fabrics configures them to interact with the fracture walls to create distributed support structures within the hydraulic fracture where the filaments or fabrics will physically collect settling proppant particles at the filament/fabric locales, particularly when a polymer is crosslinked at one or more crosslinkable site. In one non-limiting embodiment, filaments and fabrics in this case means many distributed anti-settling agents configured to act as support structures, where “support structure” means a physical object to obstruct, prevent, restrict, and otherwise control and/or inhibit proppant from sedimentation to the bottom of the hydraulic fracture by gravity. In one non-limiting embodiment the fractures are oriented vertically, or to a vertical degree i.e. where proppant settling by gravity is undesirable.

It will be appreciated that it is not necessary for the filament and/or fabric to hold the proppant fast to the fracture face in the sense of adhering it or fixing it in place. When the fracture closes on the proppant, that is the force and process that holds the proppant in a fixed place and location. The filaments and/or fabrics only need to catch, snag, hold, and/or support the proppant sufficiently to inhibit or prevent it from settling by gravity before the fracture closes. It is acceptable if the filaments and/or fabrics hold the proppant fast to the fracture face, but it is not necessary because it is expected that as the fracture closes and the space between the opposing fracture walls narrows, the proppants may be moved slightly into their permanent places under closure pressure. In other words, the proppants may be temporary suspended for a time before the fracture closes long enough for their motion downward is inhibited or prevented from settling in the bottom of the fracture. Thus, the filaments and/or fabrics must be transportable in a treatment fluid, but also have a physical shape or a shape in combination with a physical property (e.g. friction) that interacts with formation face (drag, skid, snag, catch, poke, wedge, etc.), and/or interaction in a fracture network, such as at complex fracture junctions, narrowings of hydraulic fracture, and of course the ultimate property of residing or fixating in the fracture locale once treatment pumping has been completed and be functional by design and physical properties to suspend proppant particles.

It should also be appreciated that while one filament and/or fabric may be very capable of holding one proppant in place that it is expected that multiple filaments and/or fabrics will also catch, snag, collect, and otherwise engage with one another to support and catch one or more proppant to inhibit and/or prevent the proppant from settling due to gravity.

In one simple, non-limiting embodiment the fabrics comprise a plurality of connected components or pieces, and in a different non-restrictive version, the pieces are filaments. A “filament” is defined herein as a slender threadlike object or fiber, including but not necessarily synthetic or polymer monofilament, braided filaments, continuous filaments, or natural filaments found in animal or plant structures. The pieces and/or filaments may be the same or different from one another and the filaments may of the same or different sizes, diameters, lengths, and/or widths. The plurality of filaments may involve a structure including, but not necessarily limited to, woven, non-woven, knitted, laminated, plied, spun, knotted, stacked, and combinations thereof. Thus, there is a wide variety of configurations and shapes into which the filaments may be connected. It will be appreciated that while the fabrics may be at least initially configured to have a generally flat structure and/or small cross-sectional profile to permit them to be more readily pumped downhole to be introduced into hydraulic fractures, they may optionally have, or optionally undergo a shape change to have, a three-dimensional (3D) structure as well configured to connect with and engage each other, the fracture face(s), and proppant(s). The filaments may need to have a surface treatment to provide sites that can be crosslinked, if that optional embodiment is desired. In a non-limiting example, peroxide can be used to generate —OH groups on the surface that can be used as crosslinkable sites.

The filaments and/or fabrics may come from a wide variety of sources and materials including, but not necessarily limited to, straw, wool, cotton hats, such as for cowboy, baseball, beach, etc.; gloves; paper, threaded, and other type of towels including, but not necessarily limited to shop paper towels, bath towels, etc.; padding, absorbent materials, etc.; sheets, floor mats, carpets, wall repair strip rolls, 3-D cushions in chairs, cars, etc.; fishing, hair, tennis, etc.; nets, scarfs, coats, sails, tight weaved polyester snow ski pants, various designs of overall outfits, blankets with patterns, sweaters with decorative designs, shirts designed for a wide range of purposes (e.g. dress, basketball, breathable, cold weather, stretchable, etc.), table cloths with lace borders, upper portions of shoes, etc.; and combinations of these. In an optional embodiment, the fabrics may be recycled and reused from these and other sources.

The filaments and/or fabrics may be composed of any suitable filaments, conventional or to be developed, including, but not necessary limited to, cotton, wool, silk, fiberglass, polyester, polyurethane, aramid, acrylic, nylon, polyethylene, polypropylene, polyamide, cellulose, polylactide, polyethylene terephthalate, rayon, other synthetic filaments and the like, and combinations thereof. In one non-limiting embodiment, the plurality of filaments may include, but are not necessarily limited to, polyvinyl alcohols (PVOH), polylactic acids (PLA), polyglycolic acid (PGA), modified polyethylterephthalate (PET), polyesters, polyamides, polycarbonates, and combinations thereof. By “modified PET” is meant that it has been modified to make it hydrolyzable or degradable or dissolvable in water. In one non-limiting embodiment, PVOH, PLA, PGA, modified PET, polyesters, polyamides, and polycarbonates all at least partially dissolve in water. Filament properties to be separately considered include density, diameter, length, stiffness, surface roughness, linear character (straight, curled, kinked, etc.), solubility, melt temperature, softening temperature, flexibility with heating, etc. Downhole temperatures may vary from about 38° C. to about 205° C., and thus the fabrics need to function at these temperatures. Other characteristics and properties to separately consider include, but are not necessarily limited to, stiffness, density, denier, weave, thread count, geometric design and structure (e.g. cloth, netting, etc.), longevity in the expected hydraulic fracture conditions, solubility, combinations of different threads (comingled threads, etc.), dispersibilty (in water, salt water, etc.), transportability (in polymer-viscosified fluid, in viscoelastic surfactant-viscosified fluids, and in non-viscous (water and slickwater) treatment fluids), whether the fabrics are hydrophilic or hydrophobic, and combinations of these. Of course, in one non-restrictive version herein, the strands or filaments in the fabric should be crosslinkable at the crosslinkable sites to the treatment fluid polymers like guar (including the amount and degree of crosslinkable sites on select filament strands composing fabric agent). The crosslinkable sites on different filaments may also optionally crosslink to each other.

In one non-limiting embodiment, where the fractures each have at least two opposing fracture walls across a gap, the filaments singly have at least one dimension that spans the gap between the opposing fracture walls or alternatively multiple filaments interconnected with one another spans the gap between the opposing fracture walls; e.g. the filaments are entangled, twisted, knotted, and the like. This spanning of the gap may occur before and/or in particular after the fracture closes. In another non-restrictive version, the filaments may have an average length of from about 0.1 inch independently to about 20 inches (about 0.25 to about 51 cm), in another non-restrictive version from about 1 inch independently to about 5 inches (about 2.5 to about 13 cm), alternatively from about 1.5 inches independently to about 15 inches (about 3.8 to about 38 cm), in another non-limiting embodiment from about 2 inches independently to about 12 inches (about 5.1 to about 31 cm). The term “independently” as used with respect to a range means that any lower threshold may be combined with any upper threshold to give a suitable alternate range. Further, the filaments may, in one non-restrictive version, have an average thickness of from about 0.002 inch independently to about 0.2 inch (about 0.05 mm to about 5 mm), alternatively from about 0.004 inch independently to about 0.16 inch (about 0.1 mm to about 4 mm), and in another non-limiting embodiment from about 0.008 inch independently to about 0.08 inch (about 0.2 mm to about 2 mm). In a different one non-limiting embodiment the filaments have a minimum aspect ratio of length to thickness that is about 200 to about 0.5; in a different non-restrictive version a minimum ratio of about 50 to about 1; alternatively the minimum aspect ratio is about 3 to 1.

With respect to the dimensions of the fabrics that are assemblies, constructions, and otherwise collections of filaments, it will be understood that the fractures each have at least two opposing fracture walls across a gap and that in some non-limiting embodiments the fabric singly has at least one dimension that spans the gap between the opposing fracture walls or where multiple fabrics are interconnected or entangled with one another spans the gap between the opposing fracture walls. Again, this spanning of the gap may occur before and/or in particular after the fracture closes. In one non-limiting embodiment the fabrics comprise an average length of from about 1 inch independently to about 20 inches (about 2.5 to about 51 cm), alternatively from about 1.5 inch independently to about 15 inches (about 3.8 to about 38 cm), and in another non-limiting embodiment from about 2 inches independently to about 12 inches (about 5.1 to about 31 cm). As an example, a suitable alternative average fabric length range would be from about 1.5 inch to about 15 inches.

The fabrics may have an average width of from about 0.05 inch independently to about 8 inch (about 1.3 mm to about 20 cm), alternatively from about 0.1 inch independently to about 4 inch (about 2.5 mm to about 10 cm), and in another non-limiting embodiment from about 0.2 inch independently to about 2 inches (about 5 mm to about 5.1 cm). The fabrics may have an average thickness of from about 0.002 inch independently to about 0.2 inch (about 0.05 mm to about 5 mm), alternatively from about 0.004 inch independently to about 0.16 inch (about 0.1 mm to about 4 mm), and in another non-limiting embodiment from about 0.008 inch independently to about 0.08 inch (about 0.2 mm to about 2 mm).

In one non-limiting embodiment a minimum aspect ratio for the fabrics is about 1 inch (2.5 cm) long by 0.2 inch (0.5 cm) tall by 0.1 inch (0.25 cm) thick or 5 to 1 to 0.5.

The loading or proportion of the filaments and/or fabrics in the treatment fluid, fracturing fluid or other carrier fluid, which may be water or brine, ranges from about 0.1 pounds per thousand gallons (pptg) independently to about 200 pptg (about 0.01 to about 24 kg/m³); alternatively from about 0.2 pptg independently to about 100 pptg (about 0.02 to about 12 kg/m³); and in another non-limiting embodiment from about 0.5 pptg independently to about 50 pptg (about 0.06 to about 6 kg/m³). In another non-restrictive embodiment, the method described herein for introducing the filaments into the fractures comprises employing a carrier fluid where a proportion of filaments in the carrier fluid act to interconnect other multiple individual filaments into larger connected lengths or a plurality of variable shapes, and which filaments range in concentration from about 0.01 pptg to about 20 pptg (about 0.001 to about 2.4 kg/m³). By “variable shapes” is meant that the collection or assemblages of filaments, such as into fabrics, may have a wide variety of different kinds of shapes, and additionally that the shape of each filament or assemblages or fabrics comprising filaments may have a shape that can optionally change over time, for instance is flexible, or otherwise changes or shifts as described herein.

In one non-limiting embodiment the filaments comprise a polymer chain, and where the number of crosslinkable sites along the polymer chain may range from 1:2 independently to 1:100 molar ratio of crosslinkable sites to polymer chain; alternatively from 1:5 independently to 1:80; and in another non-restrictive embodiment from 1:10 independently to 1:50. For instance, if the filament were polymer chains of polyvinyl alcohol (PVOH), there could be one organo-borate molecule to two to ten vinyl alcohol molecules comprising the polymer chain. Such a loading of crosslinkable sites would be similar for filaments comprising polymers composed of acrylamide molecules, lactide molecules, saccharide molecules, and the like—that comprise the polymer/fiber that will be combined with other fibers into a thread or filament and then further into a fabric structure. Again, only one or a few fibers up to each fiber composing a filament need be or can be modified to possess the crosslinkable sites.

The polymer may be generally any hydratable polymer known to be used to gel or viscosify a fracturing fluid which can be crosslinked. In one non-limiting embodiment, the hydratable polymer is a polysaccharide. In another non-limiting embodiment of the invention, the suitable hydratable polymers include, but are not necessarily limited to, glycol- or glycol ether-based slurry guars, hydroxypropyl guar, carboxymethylhydroxypropyl guar or other guar polymer derivatives. As noted, the hydratable polymer is crosslinked to provide an even greater viscosity or a tighter gel. Any of the common crosslinking agents may be used including, but not necessarily limited to borate ion, zirconate ion and titanate ion. These are also termed organo-borate, organo-zirconate, organo-titanate to refer to organic compounds containing these ions, respectively. In one non-limiting embodiment, a suitable crosslinker is borate ion. Borate ion, as well as the other ions, can be generated from a wide variety of ion sources as is known in the art including, but not necessarily limited to borax or sodium borate, boric acid, borate salt or borate complex, and combinations thereof. The filament polymers may thus contain a variety of crosslinkable site types.

The present invention will be explained in further detail in the following non-limiting examples that are provided only to additionally illustrate the invention but not narrow the scope thereof.

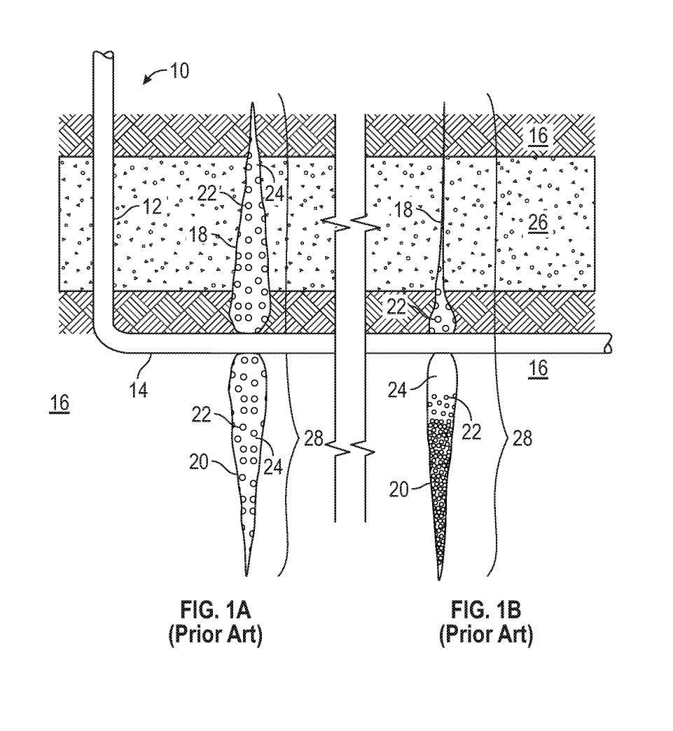

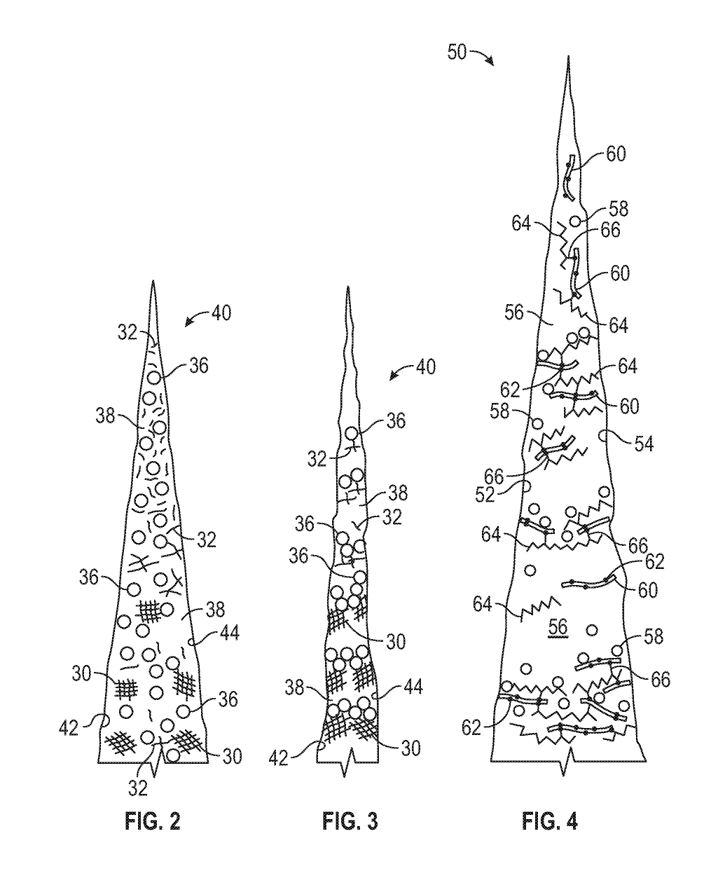

In operation, as schematically shown in FIG. 2, a plurality of filaments 32 and optionally fabrics 30 are introduced into a hydraulic fracture 40 along with proppants 36 in a uniform or non-uniform dispersion in a treatment fluid 38, which in one non-limiting embodiment may be a brine-based fracturing fluid. In a particularly suitable non-restrictive embodiment the dispersion is uniform. The fracture 40 has a first fracture face 42 and an opposing, second fracture face 44. As the pumping pressure eases or is removed, fracture faces 42 and 44 collapse toward each other and filaments 32 and fabrics 30 and proppants 36 are urged toward each other in a reduced volume. Filaments 32 and fabrics 30 singly and in groups bridge the gap between faces 42 and 44 and catch, grab, ensnare, and otherwise inhibit and prevent proppants 36 from settling by gravity and thus collections, groups, and/or assemblies of proppants 36 keep and prop the fracture 40 open after the pressure is completely released and the fracture 40 closes as much as possible, but for the presence of the proppants, as schematically illustrated in FIG. 3. Generally the fabrics 30 and filaments 32 will not be of sufficient strength or hardness to prop the fracture 40 open. It will be appreciated that a single filament and/or fabric, or groups of filaments and/or fabrics may hold, suspend, or otherwise fixate a plurality of proppant particles 36, particularly if polymer within the treatment fluid 38 is crosslinked at crosslinkable sites on the filaments 32 as will be discuss below. It will be additionally appreciated that introducing the filaments 32 and fabrics 30 into the fractures 40 can comprise a carrier fluid 38 where a proportion of filaments 32 and/or fabrics 30 in the carrier fluid 38 act to interconnect other multiple individual filaments 32 and/or fabrics 30 into larger connected lengths or a plurality of variable shapes, and which can range in concentration from about 0.01 pptg to about 20 pptg (about 0.001 to about 2.4 kg/m³). It will be further appreciated that the sizes of the proppants 36 and filaments 32 and fabrics 30 relative to the fracture 40 have been exaggerated for illustrative purposes and are not to scale. If nothing else happened, the method and composition would be a success because permeability of the fracture 40 would be improved as compared with upper fracture 18 as shown in FIG. 1B as almost completely closed or collapsed.

Shown in FIG. 4 is another embodiment of the methods and compositions described herein, where hydraulic fracture 50 has a first fracture face 52 and an opposing, second fracture face 54 into which has been pumped under pressure a brine-based fracturing fluid 56 containing proppants 58, filaments 60 and polymers 64. In the particular embodiment schematically illustrated in FIG. 4, filaments 60 have a plurality of crosslinkable sites 62 thereon, schematically illustrated as black dots. The method is designed so that a sufficient and/or effective amount of the proppants 58, filaments 60, and polymers 64 are introduced into the fracture, the polymers 64 are crosslinked by the crosslinkable sites 62 on the filaments 60 via crosslinks schematically illustrated as 66. It will be appreciated that a single crosslinkable site 62 may crosslink via crosslinks 66 more than one polymer molecule 64. Because filaments 60 bear a plurality of crosslinkable sites, a single filament 60 may crosslink to more than one polymer molecule 64, and similarly a single polymer molecule 64 may crosslink to more than one filament 60. Optionally, filaments 60 may crosslink to each other. A sufficiently high level of crosslinking of filaments 60 and polymer molecules 64 will increase the viscosity of the fracturing fluid 56 and further inhibit, prevent, engage and otherwise constrain the proppants 58 from settling and drifting lower via gravity as schematically illustrated in FIG. 4.

In the foregoing specification, the invention has been described with reference to specific embodiments thereof, and has been described as effective in providing methods and compositions for using filaments, and particularly filaments with a plurality of crosslinkable sites to inhibit or prevent the settling of proppants in fractures. However, it will be evident that various modifications and changes can be made thereto without departing from the broader scope of the invention as set forth in the appended claims. Accordingly, the specification is to be regarded in an illustrative rather than a restrictive sense. For example, specific combinations of fabrics; filaments; crosslinkable sites; threads; polymers; functional structures; proppants; treatment, fracturing and other carrier fluids; brines; dimensions; proportions; aspect ratios; materials; and other components falling within the claimed elements and parameters, but not specifically identified or tried in a particular method or composition, are anticipated to be within the scope of this invention. Similarly, it is expected that the methods may be successfully practiced using different sequences, loadings, compositions, structures, temperature ranges, and proportions than those described or exemplified herein.

The words “comprising” and “comprises” as used throughout the claims is interpreted to mean “including but not limited to”.

The present invention may suitably comprise, consist of or consist essentially of the elements disclosed and may be practiced in the absence of an element not disclosed. For instance, there may be provided a method of suspending proppants in a hydraulic fracture of a subterranean formation, where the method consists essentially of or consists of hydraulically fracturing the subterranean formation to form fractures in the formation, during and/or after hydraulically fracturing the subterranean formation, introducing proppants into the fractures, during and/or after hydraulically fracturing the subterranean formation, introducing a plurality of filaments into the fractures, where at least a portion of the filaments comprise a plurality of crosslinkable sites on the filaments, where the crosslinkable sites are selected from the group consisting of organo-borate, organo-zirconate, organo-titanate, hydroxyl groups, and combinations thereof, and closing the fractures against the proppants. Optionally, the crosslinkable sites on the filaments are chemically bonded to the filaments. Further optionally the method consists essentially of or consists of crosslinking a polysaccharide contacting the filaments with the crosslinkable sites all of which are in a carrier fluid.

In another non-limiting embodiment, there may be provided a fluid for suspending proppants in a hydraulic fracture of a subterranean formation, the fluid consisting essentially of or consisting of a carrier fluid, a plurality of filaments, where at least a portion of the filaments comprise a plurality of crosslinkable sites on the filaments, where the crosslinkable sites are selected from the group consisting of organo-borate, organo-zirconate, organo-titanate, hydroxyl groups, and combinations thereof, and a plurality of proppants.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method of suspending proppants in a hydraulic fracture of a subterranean formation, the method comprising:
hydraulically fracturing the subterranean formation to form fractures in the formation;
during and/or after hydraulically fracturing the subterranean formation, introducing proppants into the fractures;
during and/or after hydraulically fracturing the subterranean formation, introducing a plurality of filaments into the fractures, where at least a portion of the filaments comprise a plurality of crosslinkable sites on the filaments, where the crosslinkable sites are selected from the group consisting of organo-borate, organo-zirconate, organo-titanate, hydroxyl groups, and combinations thereof; and
closing the fractures against the proppants.

2. The method of claim 1 where the crosslinkable sites on the filaments are chemically bonded to the filaments.

3. The method of claim 1 where the fracture comprises at least two faces and the method further comprises the filaments interacting with the faces to inhibit the proppants from settling.

4. The method of claim 3 where introducing the filaments into the fractures comprises a carrier fluid where a proportion of filaments in the carrier fluid interconnect multiple individual filaments into larger connected lengths or a plurality of variable shapes, and which range in concentration from about 0.01 pptg to about 20 pptg (about 0.001 to about 2.4 kg/m³).

5. The method of claim 1 where the method further comprises:
contacting the filaments with a fluid comprising a polysaccharide; and
crosslinking the polysaccharide with the crosslinkable sites present on the filaments.

6. The method of claim 4 where the fractures each have at least two opposing fracture walls across a gap and where the filaments singly have at least one dimension that spans the gap between the opposing fracture walls or where multiple filaments interconnected with one another span the gap between the opposing fracture walls.

7. The method of claim 1 where the filament comprises a polymer chain, and where the number of crosslinkable sites along the polymer chain may range from 1:2 to 1:100 molar ratio of crosslinkable sites to polymer chain.

8. The method of claim 1 where the plurality of filaments is selected from the group consisting of polyvinyl alcohols (PVOH), polylactic acids (PLA), polyglycolic acid (PGA), modified polyethylterephthalate (PET), polyesters, polyamides, polycarbonates, cotton, wool, silk, fiberglass, polyurethanes, aramids, acrylics, nylons, polyethylenes, polypropylenes, cellulose, polylactide, modified polyethylene terephthalates, rayons, and combinations thereof.

9. The method of claim 1 where fabrics are present in the fractures and the fabrics comprise a plurality of filaments connected by a structure selected from the group consisting of:
woven,
non-woven,
knitted,
laminated,
plied,
spun,
knotted,
stacked, and
combinations thereof;
where at least a portion of the filaments comprise a plurality of crosslinkable sites on the filaments, where the crosslinkable sites are selected from the group consisting of organo-borate, organo-zirconate, organo-titanate, hydroxyl groups, and combinations thereof.

10. The method of claim 9 where the fabrics comprise at least a one first filament and at least one second filament, and the method further comprises changing a parameter selected from the group consisting of temperature, chemical composition, dissolving at least a portion of one of the filaments, dissolving a filament, hydrolyzing a filament, an actuation due to an applied stress or force or magnetic or electric field, and a combination thereof which parameter changing causes a shape change in at least one of the filaments.

11. The method of claim 9 where the fabrics comprise at least one shape-changing filament where the shape-changing filament has a first shape and a subsequent shape and the method further comprises:
introducing the fabrics into the fractures when the shape-changing filament has a first shape; and
the shape-changing filaments changing shape after a period of time within the fractures.

12. The method of claim 1 where the filaments comprise:
an average length of from about 0.1 inch to about 20 inches (about 0.25 to about 51 cm); and
an average thickness of from about 0.002 inch to about 0.2 inch (about 0. 05 mm to about 5 mm).

13. The method of claim 1 where the filaments have a minimum aspect ratio of length to thickness is 200 to 0.5.

14. The method of claim 1 where introducing the filaments into the fractures comprises employing a carrier fluid where a proportion of filaments in the carrier fluid ranges from about 0.1 pptg to about 200 pptg (about 0.01 to about 24 kg/m³).

15. A fluid for suspending proppants in a hydraulic fracture of a subterranean formation, the fluid comprising:
a carrier fluid;
a plurality of filaments, where at least a portion of the filaments comprise a plurality of crosslinkable sites on the filaments, where the crosslinkable sites are selected from the group consisting of organo-borate, organo-zirconate, organo-titanate, hydroxyl groups, and combinations thereof; and
a plurality of proppants.

16. The fluid of claim 15 where the crosslinkable sites on the filaments are chemically bonded to the filaments.

17. The fluid of claim 15 where the filament comprises a polymer chain, and where the number of crosslinkable sites along the polymer chain may range from 1:2 to 1:100.molar ratio of crosslinkable sites to polymer chain.

18. The fluid of claim 15 where the plurality of filaments is selected from the group consisting of polyvinyl alcohols (PVOH), polylactic acids (PLA), polyglycolic acid (PGA), modified polyethylterephthalate (PET), polyesters, polyamides, polycarbonates, cotton, wool, silk, fiberglass, polyurethanes, aramids, acrylics, nylons, polyethylenes, polypropylenes, celluloses, polylactides, modified polyethylene terephthalates, rayons, and combinations thereof.

19. The fluid of claim 15 where the filaments comprise:
an average length of from about 0.1 inch to about 20 inches (about 0.25 to about 51 cm); and
an average thickness of from about 0.002 inch to about 0.2 inch (about 0.05 mm to about 5 mm).

20. The fluid of claim 15 where the filaments have a minimum aspect ratio of length to thickness is 200 to 0.5.

21. The fluid of claim 15 where a proportion of filaments in the carrier fluid ranges from about 0.1 pptg to about 50 pptg (about 0.01 to about 6 kg/m³).
